(19) United States
(12) Patent Application Publication
(10) Pub. No.: US 2019/0273393 A1
(43) Pub. Date: Sep. 5, 2019

(54) ENERGY MANAGEMENT SYSTEM, METHOD AND DEVICE FOR MAXIMIZING POWER UTILIZATION FROM ALTERATIVE ELECTRICAL POWER SOURCES

(71) Applicant: Chengwu Chen, Pepeekeo, HI (US)

(72) Inventor: Chengwu Chen, Pepeekeo, HI (US)

(21) Appl. No.: 16/041,631

(22) Filed: Jul. 20, 2018

Related U.S. Application Data
(60) Provisional application No. 62/638,060, filed on Mar. 3, 2018.

(51) Int. Cl. H02J 9/06; H02J 3/38

(52) U.S. Cl. CPC H02J 9/062; H02J 3/386; H02J 3/383

(57) ABSTRACT

An energy management device of an energy management system includes a first input terminal connecting with a first backup electrical power source; a second input terminal connecting with a second normally on electrical power source; an output terminal connecting with an electrical panel of a facility; a switching device for providing a path between the output terminal and one of the first input terminal and the second input terminal; a current transformer measuring a current flow across the path; and a power management unit configured to control the switching device to switch the path to the first input terminal when a power value calculated based upon at least one of the measured current flow and a measured voltage on the path is greater than a predetermined power rating associated with the second normally on electrical power source, the predetermined power rating greater than zero.

### CROSS-REFERENCE TO RELATED APPLICATIONS

The present application claims the benefit of U.S. Provisional Patent Application No. 62/638,060 filed on Mar. 3, 2018, the contents of which are incorporated herein by reference.

### TECHNICAL FIELD

The technical field relates generally to electrical power systems and, more particularly, to a system, method and device for maximizing power utilization from an alternative electrical power source.

### BACKGROUND

Electrical power is conventionally supplied from a local electric utility service via an electrical grid to residential and commercial establishments. The local electric utility service may generate electrical power by fossil fuels, nuclear power or even renewable sources.

Alternative electrical power sources (AEPS) can be any form of power source that may or may not be directly connected to the local electrical grid. Recently, usage of AEPS by residential and commercial establishments has increased.

### SUMMARY

Referring to FIG. 1, an exemplary operating environment is shown in which a residential establishment 10 receives electrical power from an electrical utility service via the electrical grid (depicted by 20) and from AEPS 30.

The AEPS 30 can be, for example, gas/diesel generators 302, waste/trash to energy power sources 304, wind-turbine alternators/generators 306, geothermal 308, solar electric inverters with and without energy storage 310, hydro-turbine alternators/generator 312, uninterrupted power supply systems (not shown), etc.

FIG. 2 shows an arrangement for receiving electrical power from the electrical grid 20 at the establishment 10. A meter 202 provided by the electric utility company is connected to the grid 20 via service conductors which can be overhead service conductors (as depicted in FIG. 1) or through an underground conduit (not shown). The meter 202 is also connected to an electrical panel 204 at the residence. The meter 202 measures the current flow and can be utilized to determine peak power demands. The meter 202 can include a main disconnect or multiple disconnects to disconnect the power flow.

For reasons such as environmental concerns and/or costs reduction, the establishment 10 may prefer to receive as much electrical power as necessary from the AEPS 30, while still retaining access to electrical power from the electrical grid 20 to meet demand.

According to various embodiments, the system includes an energy management device connected to electrical power sources and an electrical panel.

In a first embodiment, the energy management device includes: a first input terminal connecting with a first backup electrical power source; a second input terminal connecting with a second normally on electrical power source; an output terminal connecting with the electrical panel; a switching device providing a path between the output terminal and one of the first input terminal and the second input terminal; a current transformer (CT) measuring a current flow across the path; and a power management unit (PMU) configured to control the switching device to switch the path to the first input terminal when a power value calculated based upon at least one of the measured current flow and a measured voltage on the path is greater than a predetermined power rating associated with the second normally on electrical power source, the predetermined power rating greater than zero.

The PMU can be further configured to control the switching device to switch the path back to the second input terminal when the power value calculated based upon the at least one of the measured current flow and the measured voltage is less than the predetermined power rating associated with the second normally on electrical power source.

A default state of the switching device can be set to the second terminal so that the electrical panel receives electrical power from the second normally on electrical power source, which is an AEPS.

The energy management device can further include a voltage sensing circuit measuring the voltage across the path.

The switching device can be a latching contactor.

The energy management device can further include: a reversing contactor including first and second coils connected to the first and second input terminals, wherein the switching device is a relay, wherein the PMU is connected to the first and second coils of the reversing contactor via a relay coil included in the relay, the PMU is configured to switch between activating the first coil and the second coil and thereby switch the path to the output terminal between the first input terminal and the second input terminal based upon the at least one of the measured current flow and the measured voltage by energizing the relay coil.

The energy management device can include a curtailment switch arranged to switch a connection to one of a first terminal and a second terminal, the curtailment switch including a coil energized when current flows through the first input terminal.

The electrical panel can include a first circuit breaker for preventing power to a plurality of circuits when the coil associated with the curtailment switch is not energized.

In a second embodiment, the energy management device includes: a first input terminal connecting with a first backup electrical power source; a second input terminal connecting with a facility electrical panel to receive electrical power via a meter from a second normally on electrical power source; a CT measuring a current flow across an exterior path between the facility electrical panel and the meter; and a PMU configured to measure a voltage across an interior path between a load diversional electrical panel and one of the first input terminal and the second input terminal, wherein the PMU is configured to switch the interior path between the first input terminal and the second input terminal based upon the measured current flow on the exterior path.

The PMU is further configured to: measure a second current flow value on the exterior path; determine whether the measured second current flow value is greater than a predetermined current flow rating; and control the switching device to switch the interior path to the first input terminal when the measured second current flow value is greater than the predetermined current flow rating, the second predetermined current flow rating greater than zero.

The PMU can be further configured to control the switching device to switch the path back to the second input terminal when the measured second current flow value becomes less than the second predetermined current flow rating.

The energy management device can further comprise: a general purpose contactor including a coil connected to the PMU, the general purpose contactor connected to a battery charger and the electrical panel, the battery charger configured to charge a battery which is the first backup electrical power source, wherein the PMU is further configured to energize the coil of the general purpose contactor while the measured second current value is less than the predetermined current flow rating.

In a third embodiment, the energy management device comprises: an output terminal connecting with a meter associated with a first electrical power source; an input terminal connecting with a facility electrical panel for exporting power to the first electrical power source via the output terminal; a PMU including: a CT measuring a current flow across an interior path from the first input terminal to the output terminal; a PT measuring a voltage across the interior path; and a load diversion controller (LDC) connected to the electrical panel and a load, the LDC including a general purpose contactor and a coil, the LDC configured to provide electrical power to the load during a specific time period while the coil is energized by the PMU.

The PMU calculates a power based upon at least one of the measured current flow and the measured voltage on the interior path, and when the PMU determines that the calculated power is greater than a first predetermined power value, the PMU energizes the coil in the LDC.

The LDC includes a first timing device set for a first timing value associated with the load, wherein when the coil in the LDC is activated by the PMU the LDC continues to provide power to the load until the first timing value set by the first timing device expires.

The LDC includes a second timing device set for a second timing value associated with the load, wherein the LDC provide power to the load until the second timing value set by the second timing device expires.

The system can further include: an inverter connected to the second electrical power source, the inverter providing electrical power to the electrical panel to be exported to the second electrical power source, wherein the inverter is coupled to a charger controller for charging a battery and is configured to energize the coil in the LDC when the battery is charged to a predetermined amount.

The second electrical power source can be an alternative electric power source (AEPS) charging a battery, wherein the inverter further comprising an auxiliary output terminal for activating the LDC after the battery has been charged by the battery charger.

### BRIEF DESCRIPTION OF THE DRAWINGS

The accompanying figures, in which like reference numerals refer to identical or functionally similar elements, together with the detailed description below are incorporated in and form part of the specification and serve to further illustrate various exemplary embodiments and explain various principles and advantages in accordance with the present invention.

FIG. 1 illustrates an exemplary operating environment in which a residence receives electrical power from various sources.

FIG. 2 is a block diagram illustrating exemplary portions of a conventional electric utility service connection.

FIG. 3 is a block diagram illustrating exemplary portions of an energy management system (EMS) according to a first embodiment.

FIG. 4 is a block diagram illustrating exemplary portions of the EMS according to a modification to the first embodiment.

FIG. 5 is a block diagram illustrating exemplary portions of the EMS according to a modification to the first embodiment.

FIG. 6 is a block diagram illustrating exemplary portions of the EMS according to a modification to the first embodiment.

FIG. 7 is a block diagram illustrating exemplary portions of the EMS according to a modification to the first embodiment.

FIG. 8 is a block diagram illustrating exemplary portions of the EMS according to a modification to the first embodiment.

FIG. 9 is a block diagram illustrating exemplary portions of an EMS according to a modification to the first embodiment.

FIG. 10 is a block diagram illustrating exemplary portions of an EMS according to a modification to the first embodiment.

FIGS. 11A-11B are electrical wiring diagrams for an exemplary implementation of the EMS shown in FIG. 9.

FIG. 12 is a block diagram illustrating exemplary portions of an EMS according to a second embodiment.

FIG. 13 is a block diagram illustrating exemplary portions of an EMS according to a modification to the second embodiment.

FIG. 14 is a block diagram illustrating exemplary portions of an EMS according to a third embodiment.

FIG. 15 is a block diagram illustrating exemplary portions of an EMS including a Load Diversion Controller (LDC) according to a fourth embodiment.

FIG. 16 is a block diagram illustrating exemplary portions of the EMS according to a modification to the fourth embodiment.

FIG. 17 is a block diagram illustrating exemplary portions of the EMS according to a modification to the fourth embodiment.

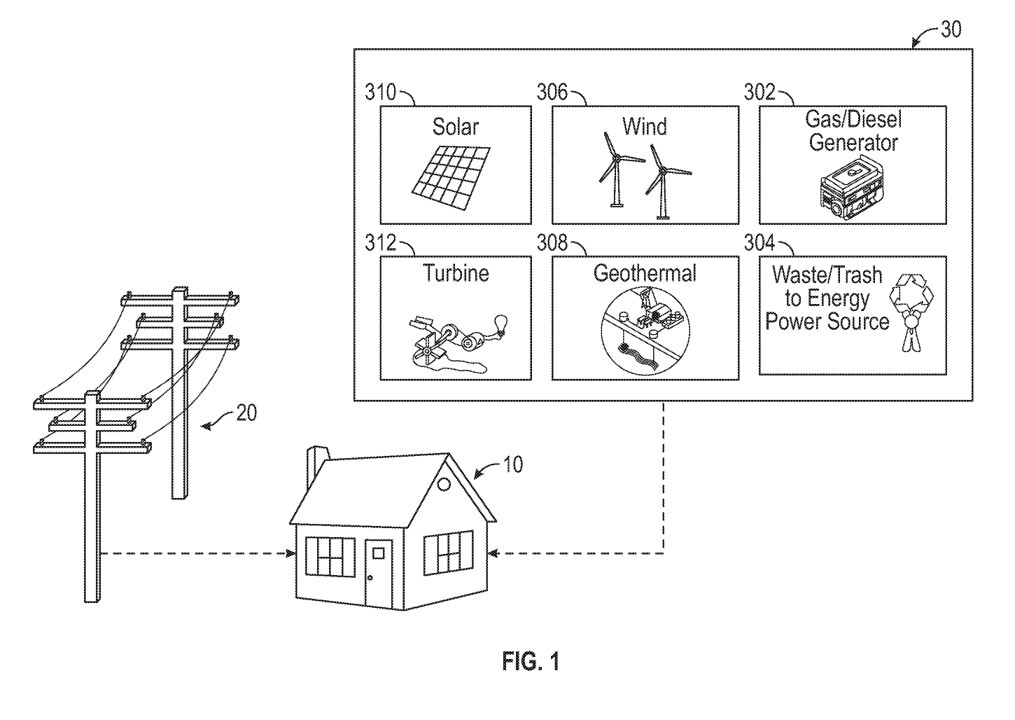

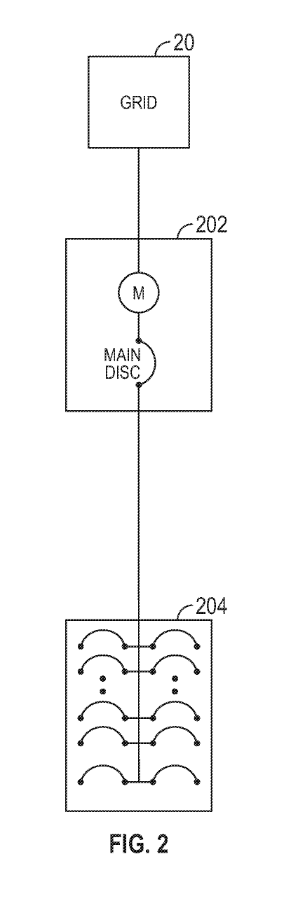

### DETAILED DESCRIPTION

In overview, the present disclosure concerns an energy management system (EMS) which includes meters connected to electrical power sources, electrical panels connected to the meters, and an energy management device to maximize power utilization from one or more of the electrical power sources.

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Reference will now be made in detail to the accompanying drawings. Wherever possible, the same reference numbers will be used throughout the drawings to refer to the same or like parts.

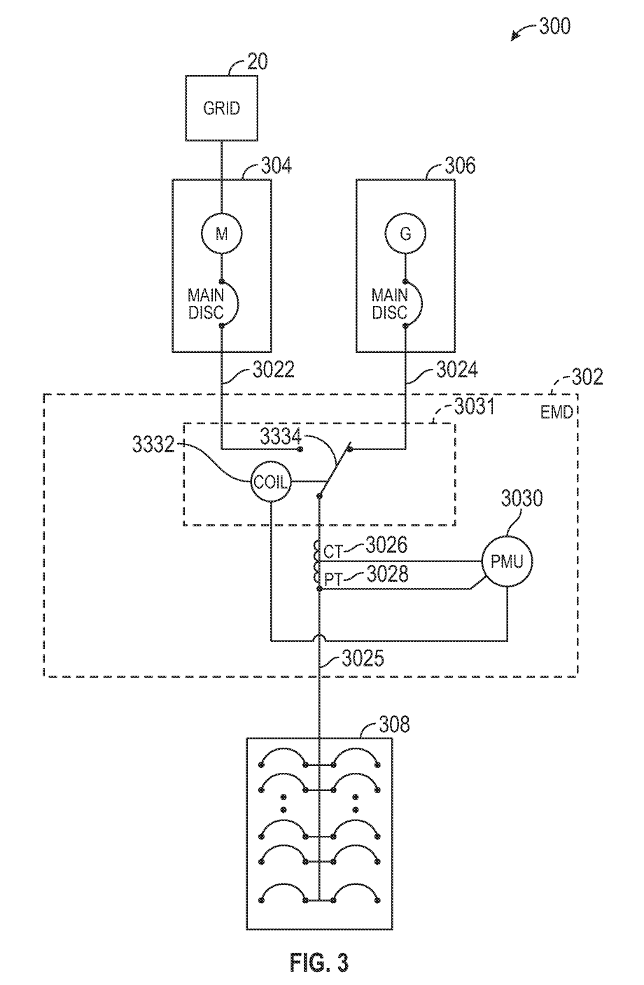

Referring to the block diagram of FIG. 3, portions of an exemplary EMS 300 will be discussed. The EMS 300 includes an energy management device (EMD) 302 connected to a meter 304, which receives electrical power from the grid 20, an AEPS 306 and an electrical panel 308. In this example, the EMD 302 is connected to only two electrical power sources, but the EMS 300 is not limited to such a configuration. For example, the EMD 302 could be connected to three or more electrical power sources (grid and two or more AEPSs, etc.). However, in the EMS 300 the electrical power from the grid 20 is set as the backup electrical power source while the electrical power from the AEPS 306 is set as the normally on electrical power source.

The electrical panel 308 includes a plurality of circuits for distributing the power to various devices (not shown).

The EMD 302 includes a first input terminal 3022 connecting with the meter 304 of the first backup electrical power source, a second input terminal 3024 connecting with the AEPS (second normally on electrical power source) 306 and an output terminal 3025 connecting with the electrical panel 308. The EMD 302 includes a current transformer (CT) 3026 measuring a current flow across a path between the electrical panel 308 and one of the first input terminal 3022 and the second input terminal 3024. The EMD 302 also includes a voltage sensor such as, for example, a potential transformer (PT) 3028 for measuring voltages on the path.

The EMD 302 includes a latching contactor 3031 for switching between the first input terminal 3022 and the second input terminal 3024. The latching contactor 3031 includes a coil 3332 and a switch 3334 for switching the connection to the output terminal 3025 between one of the input terminals 3022, 3024 when the coil 3332 is energized.

The EMD 302 includes a power management unit (PMU) 3030 that controls the latching contactor 3031 to switch the path to the electrical panel 308 from between the first input terminal 3022 and the second input terminal 3024 based upon at least one of the measured current flow and measured voltage. The output from the CT 3036 and the PT 3028 are the inputs to the PMU 3030. The output of the PMU 3030 is connected to the coil 3332 which can activate the switch 3334. Alternatively, for voltages of 600 V or less, rather than the PT 3028, a meter in the PMU 3030 can measure the voltage. The PMU 3030 can be a multifunction power meter which includes generally a microcontroller with metering capability for calculating the power based upon the measured current and voltage and configured to compare the calculated power with a predetermined power associated with the rating of the AEPS 306 and generate a transfer signal to energize the coil 3332.

During a normal operation condition, the connection path is between the electrical panel 308 and the second terminal 3024 and thus the AEPS 306. In normal operation, the switch 3334 is connected to the second terminal 3024. A normal operation condition can be the facility demand is within the rating of the AEPS 306 so that the AEPS 306 can handle the demand. When PMU 3030 determines, based upon the measured current and/or voltage, that the facility demand is greater than the rating of the AEPS 306, the PMU 3030 initiates a transfer command to switch the electrical path to the first input terminal 3022 and thus the grid 20. Particularly, the PMU 3030 sends a transfer signal that energizes the coil 3332, which makes the switch 3334 connect the path to the first terminal 3022. The PMU 3030 continues to monitor the current/voltage. When the demand is back to within the rating of the AEPS 306, the PMU 3030 again generates the transfer signal to energize the coil 3332, which makes the switch 3334 connect the path to the second terminal 3024, thereby returning to normal operation.

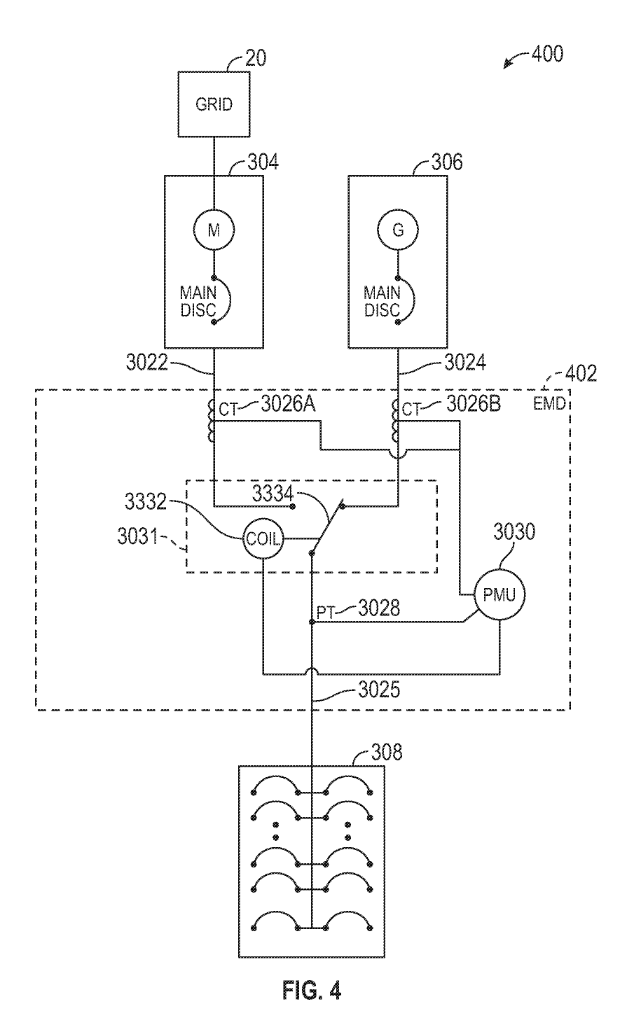

Referring to the block diagram of FIG. 4, portions of an exemplary EMS 400 according to a first modification will be discussed. The same portions shown in FIG. 3 have the same reference numerals and a detailed discussion is omitted.

The EMD 402 includes first CT 3026A and second CT 3026B on the source side of the latching contactor 3031 to measure a current flow across both the first input terminal 3022 and the second input terminal 3024. The PMU 3030 can sum the two current measurements from first CT 3026A and second CT 3026B to measure the power demand of the EMS 400. Otherwise, operation is similar to the EMS 300.

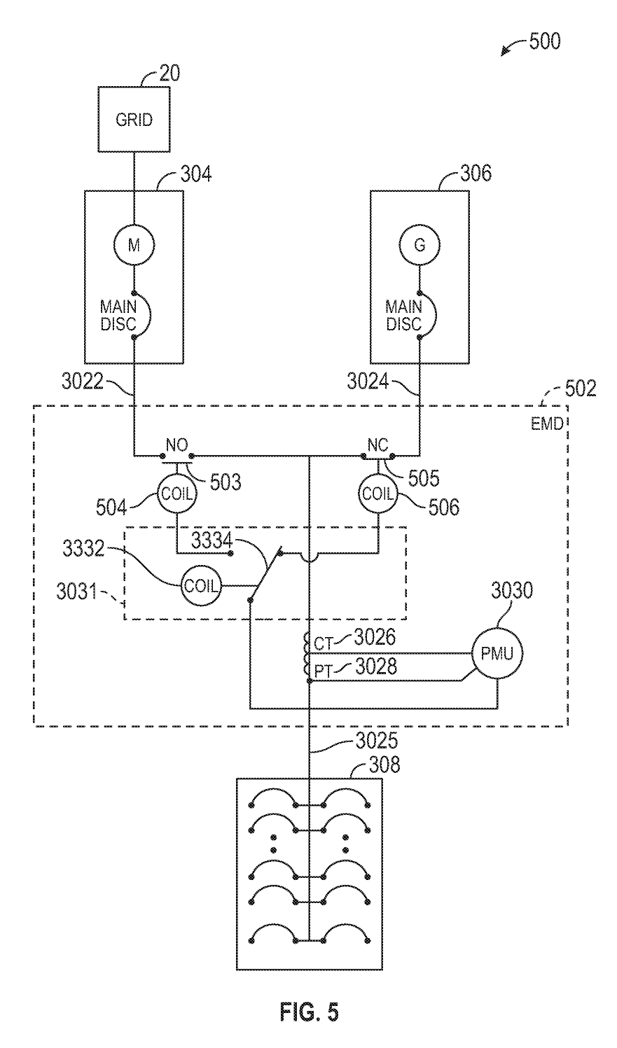

Referring to the block diagram of FIG. 5, portions of an exemplary EMS 500 according to a second modification will be discussed. The same portions shown in FIG. 3 have the same reference numerals and a detailed discussion is omitted.

The EMD 502 includes a first general purpose contactor 503 connected to the first terminal 3022 and a second general purpose contactor 505 connected to the second terminal 3024. Each of the contactors 503, 505 includes a coil 504, 506. The output of the latching contactor 3031 is connected to the coils 504, 506.

When the PMU 3030 determines, based upon the measured current and/or voltage, that the facility demand is greater than the rating of the AEPS 306, the PMU 3030 initiates a transfer command to switch the electrical path to the first input terminal 3022 and thus the grid 20. Particularly, the PMU 3030 sends a transfer signal that energizes the coil 3332, which makes the switch 3334 connect the path to energize the coil 504 of the first contactor 503 and close the normally open first general purpose contactor 503 while deenergizing the coil 506 to open the normally closed second general purpose contactor 505.

The PMU 3030 continues to monitor the current/voltage. When the demand is back to within the rating of the AEPS 306, the PMU 3030 again generates the transfer signal to energize the coil 3332, which makes the switch 3334 connect the path to the coil 506 of the second contactor 505, thereby returning to normal operation. Otherwise, operation is similar to the EMS 300.

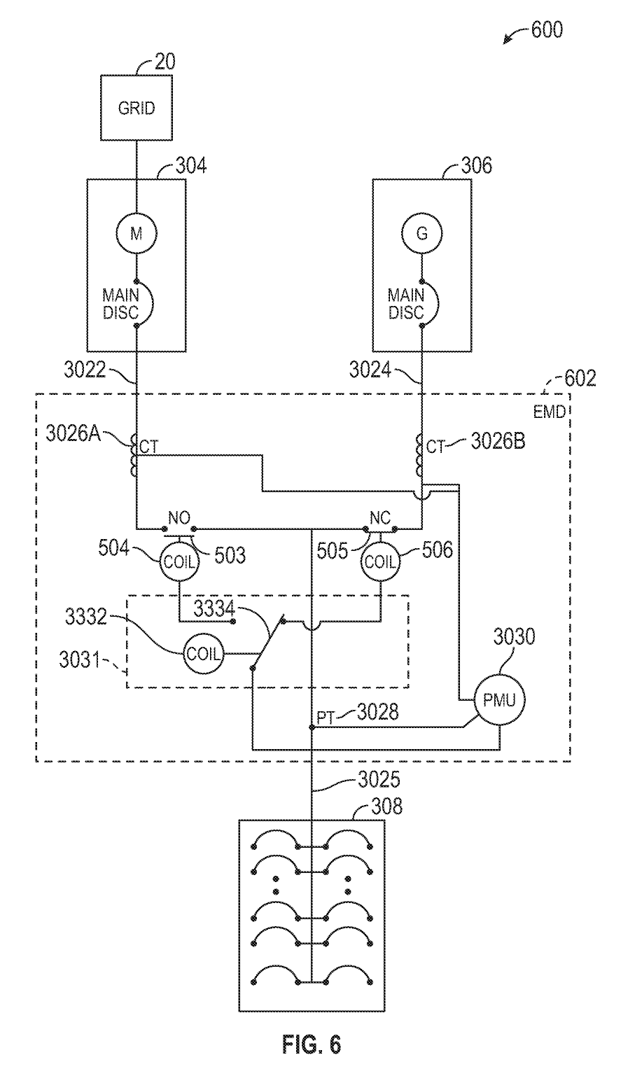

Referring to the block diagram of FIG. 6, portions of an exemplary EMS 600 according to a third modification will be discussed. The same portions shown in FIG. 5 have the same reference numerals and a detailed discussion is omitted.

The EMD 602 includes a first CT 3026A connected to the first input terminal 3022 and a source side of a first general purpose contactor 503. The EMD 602 also includes a second CT 3026B connected to the second input terminal 3024 and a source side of the second general purpose contactor 505. Similar to as shown in FIG. 4, the PMU 3030 can sum the two current measurements to measure the power demand of the EMS 400. Otherwise, operation is similar to the EMS 500.

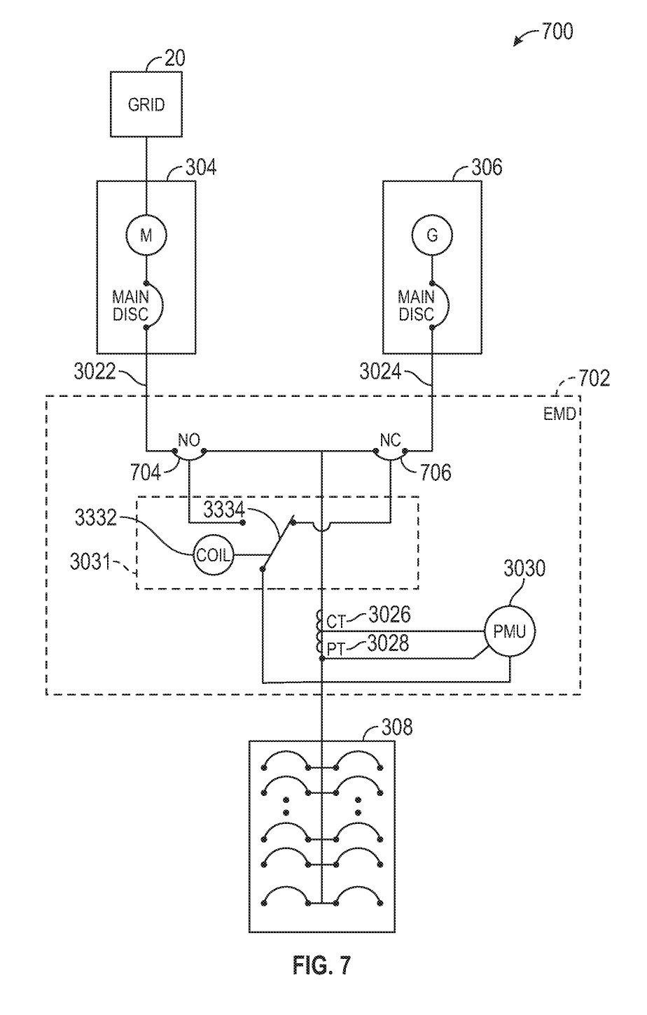

Referring to the block diagram of FIG. 7, portions of an exemplary EMS 700 according to a fourth modification will be discussed. The same portions shown in FIG. 3 have the same reference numerals and a detailed discussion is omitted.

The EMD 702 includes a first remote operated circuit breaker 704 connected to the first input terminal 3022 and a second remote operated circuit breaker 706 connected to the second input terminal 3024. The output of the latching contactor 3031 controls the circuit breakers.

When PMU 3030 determines, based upon the measured current and/or voltage, that the facility demand is greater than the rating of the AEPS 306, the PMU 3030 initiates a transfer command to switch the electrical path to the first input terminal 3022 and thus the grid 20. Particularly, the PMU 3030 sends a transfer signal that energizes the coil 3332, which makes the switch 3334 connect the path to close the normally open first remote operated circuit breaker 704 while opening the normally closed second remote operated circuit breaker 706.

The PMU 3030 continues to monitor the current/voltage. When the demand is back to within the rating of the AEPS 306, the PMU 3030 again generates the transfer signal to energize the coil 3332, which makes the switch 3334 connect to the path to the second remote operated circuit breaker 706, thereby returning to normal operation. Otherwise, operation is similar to the EMS 300.

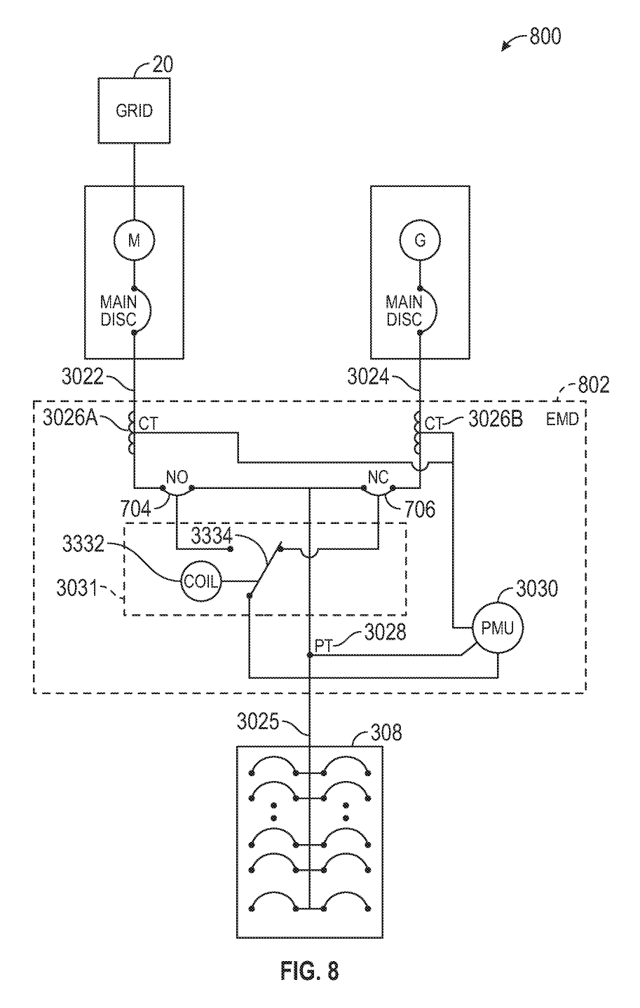

Referring to the block diagram of FIG. 8, portions of an exemplary EMS 800 according to a fifth modification will be discussed. The same portions shown in FIG. 7 have the same reference numerals and a detailed discussion is omitted.

The EMD 802 includes a first CT 3026A connected to the first input terminal 3022 and a source side of a first circuit breaker 704 and a second CT 3026B connected to the second input terminal 3024 and a source side of the second circuit breaker 706. Similar to as shown in FIG. 4, the PMU 3030 can sum the two current measurements to measure the power demand of the EMS 800. Otherwise, operation is similar to the EMS 700.

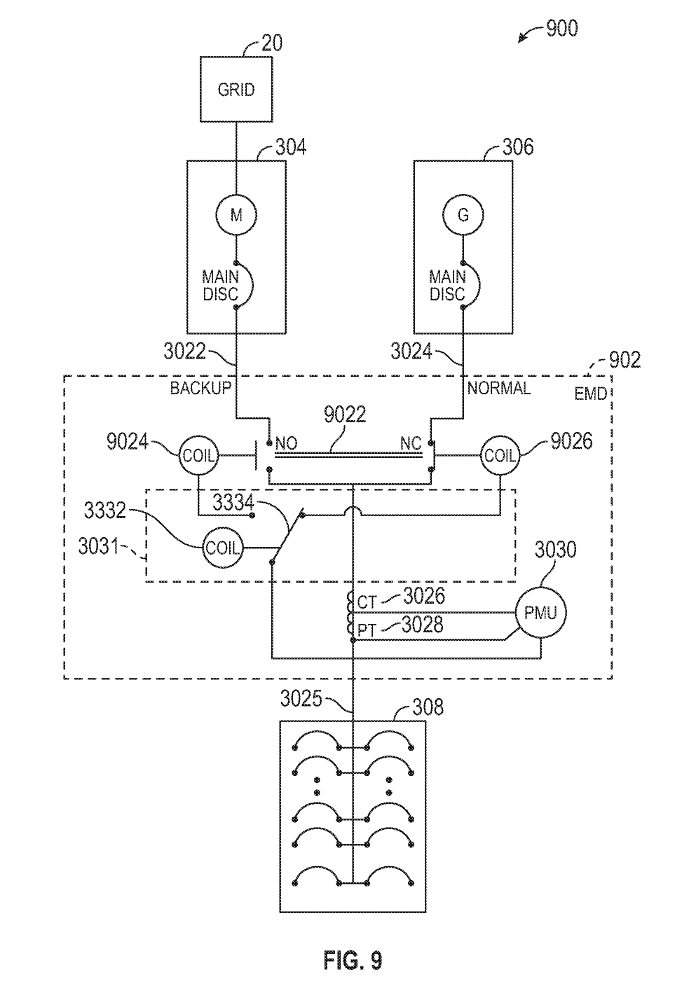

Referring to the block diagram of FIG. 9, portions of an exemplary EMS 900 according to a fifth modification will be discussed. The same portions shown in FIG. 3 have the same reference numerals and a detailed discussion is omitted.

The EMD 902 includes a reversing contactor 9022 connecting the first and second input terminals 3022, 3024 to the output terminal 3025 to the electrical panel 308. The reversing contactor 9022 include first and second coils 9024, 9026 connected to the switch output of the latching contactor 3031.

The PMU 3030 is connected to the first and second coils 9024, 9026 via the latching contactor 3031. The PMU 3030 is configured to switch between activating the first coil 9024 and the second coil 9026 and thereby switch the path between the first input terminal 3022 and the second input terminal 3024 based upon the measured current flow at the CT 3026 and the measured voltage 3028 by energizing the relay coil 3332. Particularly, the PMU 3030 can send the transfer signal to the coil 3332 in the latching contactor 3031 as discussed above to perform the switching. Otherwise, operation is similar to the EMS 300.

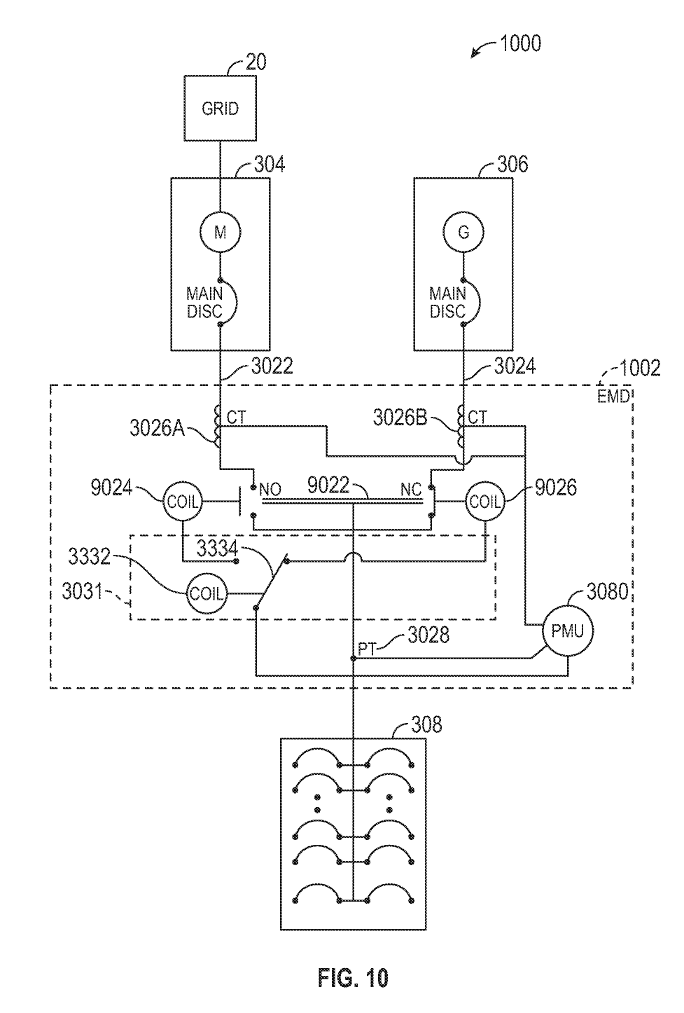

Referring to the block diagram of FIG. 10, portions of an exemplary EMS 1000 according to a sixth modification will be discussed. The same portions shown in FIG. 9 have the same reference numerals and a detailed discussion is omitted.

The EMD 1002 includes a first CT 3026A connected to the first input terminal 3022 and a source side of the reversing contactor 9022. The EMD 1002 also includes a second CT 3026B connected to the second input terminal 3024 and a source side of the reversing contactor 9022. Similar to as shown in FIG. 4, the PMU 3030 can sum the two current measurements to measure the power demand of the EMS 1000. Otherwise, operation is similar to the EMS 900.

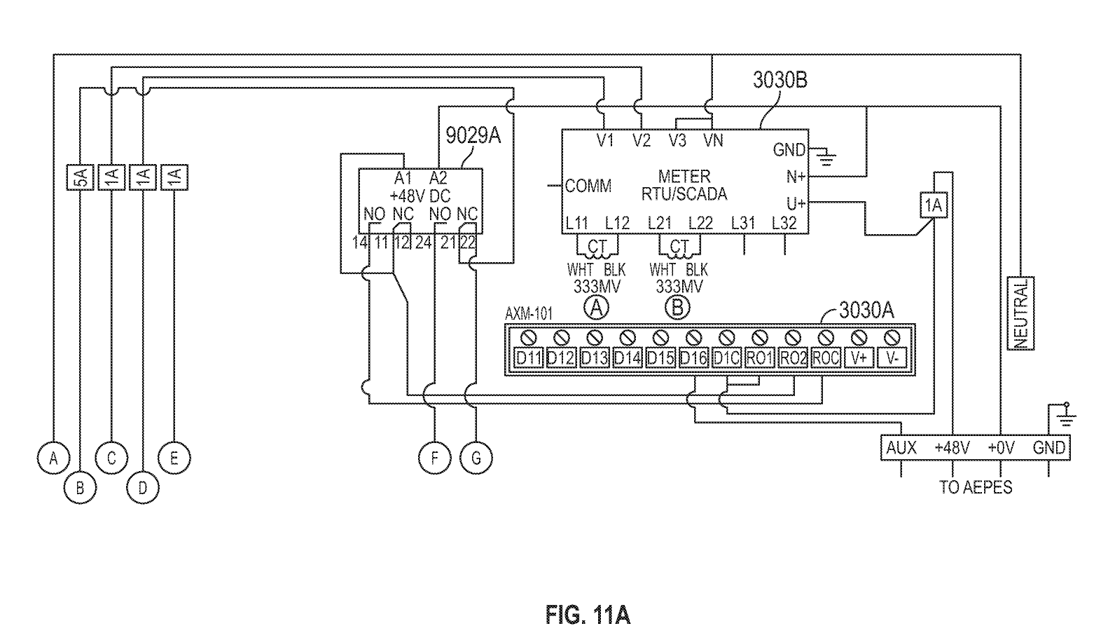

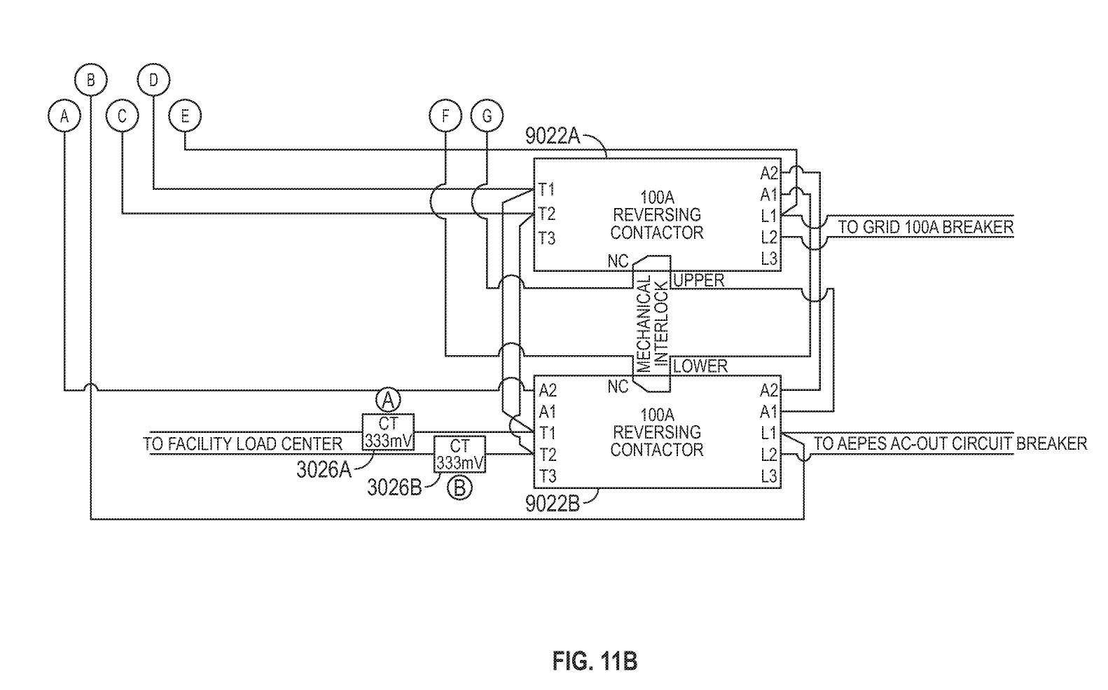

Referring to FIGS. 11A-11B, an example wiring arrangement for implementing the EMS 900 of FIG. 9 will be discussed. The reversing contactor 9022 is implemented by two 100 A general purpose contactors 9022A, 9022B connected by a mechanical interlock so that only one can be activated at a time. Two phase lines (“T1” and “T2”) are output to the facility load center (electrical panel 908). The PMU 3030 includes an AXM-101 unit 3030A and a meter (RTU/SCADA) 3030B. The meter 3030B receives the current values from the 333 mV CTs (3026A, 3026B) and voltage values (V1, V2) of the two phase lines. The PMU 3030 sends the transfer signal to the coil of the latching relay 9029A to perform the switching. For this particular wiring arrangement and particular components utilized, the meter 3030B and AXM-101 3030A require 48V DC power source. The coils of reversing contactor 9022A and 9022B require 120V AC power source. For another particular wiring arrangement and components utilized, the power requirement for meter 3030B and AXM-101 3030A and the coils of the reversing contactor 9022A and 9022B may be different.

Note that the arrangement in the EMS according to the above embodiments is different from a typical standby generator design in which the meter 304 to the grid 20 would be the normal supply and the AEPS 306 would be the backup. Further, a typical standby generator determines the switching solely based upon voltage measurement from the grid 20. Particularly, in a conventional standby generator arrangement the power source is switched only when no voltage is detected from the grid 20. However, the EMS 300 determines when to switch based not solely upon voltage measurement, but whether the power (current/voltage flow) can meet the demand. Accordingly, the EMS of the various embodiments discussed herein leads to the superior effect of allowing the AEPS 306 to supply a majority of the energy needs of the facility. Particularly, all devices connected to the electrical panel 308 can be supplied power by the AEPS 306 rather than only the critical loads.

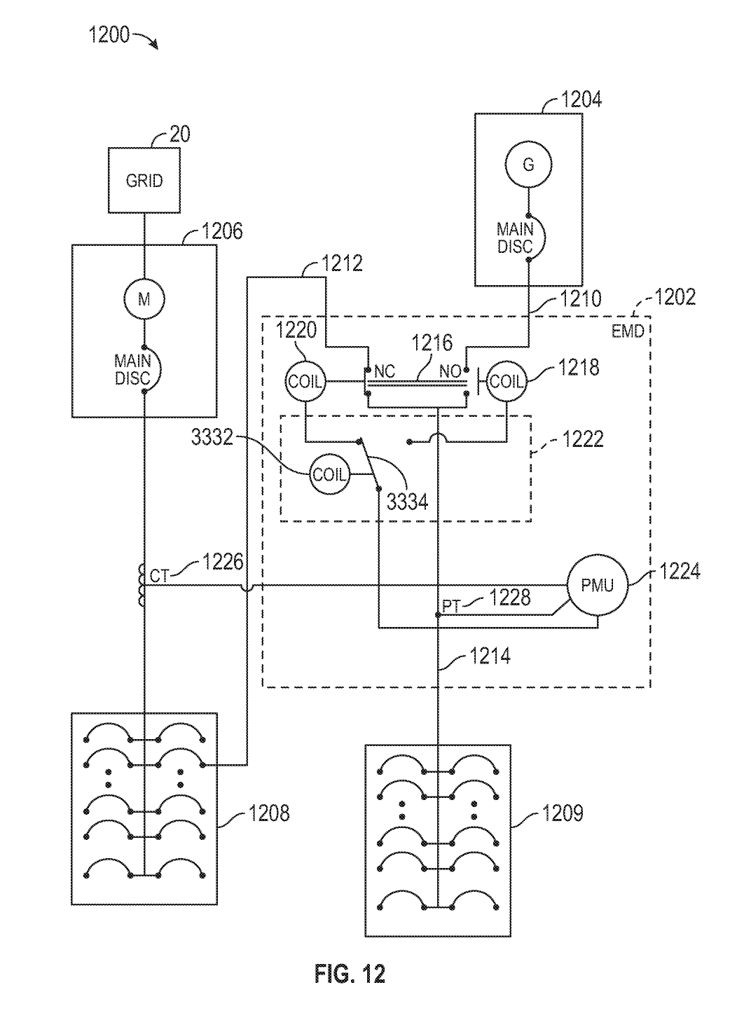

Referring to FIG. 12, portions of an exemplary EMS 1200 according to a second embodiment will be discussed. The EMS 1200 includes an EMD 1202, an AEPS 1204, a meter 1206, which receives electrical power from the grid 20, a facility electrical panel 1208, and a load diversion electrical panel 1209. In this EMS 1200, the electrical power from the AEPS 1204 is set as the backup electrical power source while the electrical power from the grid 20 is set as the normally on electrical power source. The EMS 1200 reduces the peak power demand from the grid 20.

The EMD 1202 includes a first input terminal 1210 connecting with the AEPS 1204 (first backup electrical power source), a second input terminal 1212 connecting with a circuit of the facility electrical panel 1208 and an output terminal 1214 connected to the load diversion electrical panel 1209.

The EMD 1202 includes a reversing contactor 1216 connecting the first and second input terminals 1210, 1212 to the output terminal 1214. The reversing contactor 1216 include first and second coils 1218, 1220 connected to the switch output of a latching relay 1222. The latching relay 1222 switches between energizing the first and second coils 1218, 1220.

The EMD 1202 includes a PMU 1224 configured to measure a voltage at the output terminal 1214. The PMU 1224 is connected to a CT 1226 which measures a current flow across an exterior path between the facility electrical panel 1208 and the meter 1206 (second normally on electrical power source). The PMU 1224 is configured to energize the coil 3332 of the latching relay 1222 to switch the interior path to the output terminal 1214 from between the first and second input terminals 1210, 1212 based upon the measured current flow on the exterior path.

When the facility electrical demand at the panel 1208 exceeds a predetermined level, the EMS 1200 initiates a transfer command so that the AEPS 1204 provides power to the load diversion electrical panel 1209, thereby reducing the power demand from the grid 20. Particularly, the PMU 1224 is configured to measure current flow on the exterior path from the CT 1226; determine whether a second measured current flow value is greater than a predetermined current flow rating associated with the grid 20 (second normally on electrical power source); and control the latching relay 1222 by energizing the relay coil to switch the path to the first input terminal 1210 when the measured second current flow value is greater than a predetermined current flow rating associated with the second normally on electrical power source which is greater than zero.

Once the grid power demand drops below a predetermined level, the EMS 1200 initiates a transfer command to return the connection back to the grid 20. Once again, here the PMU 1224 is configured to control the switching device 1222 to switch the path back to the second input terminal 1212 when the measured current flow is determined to be less than the predetermined current flow rating associated with the second normally on electrical power source. This EMS 1200 controls peak power demand from the grid. Therefore, normal operation is the grid 20 while backup is the AEPS 1204.

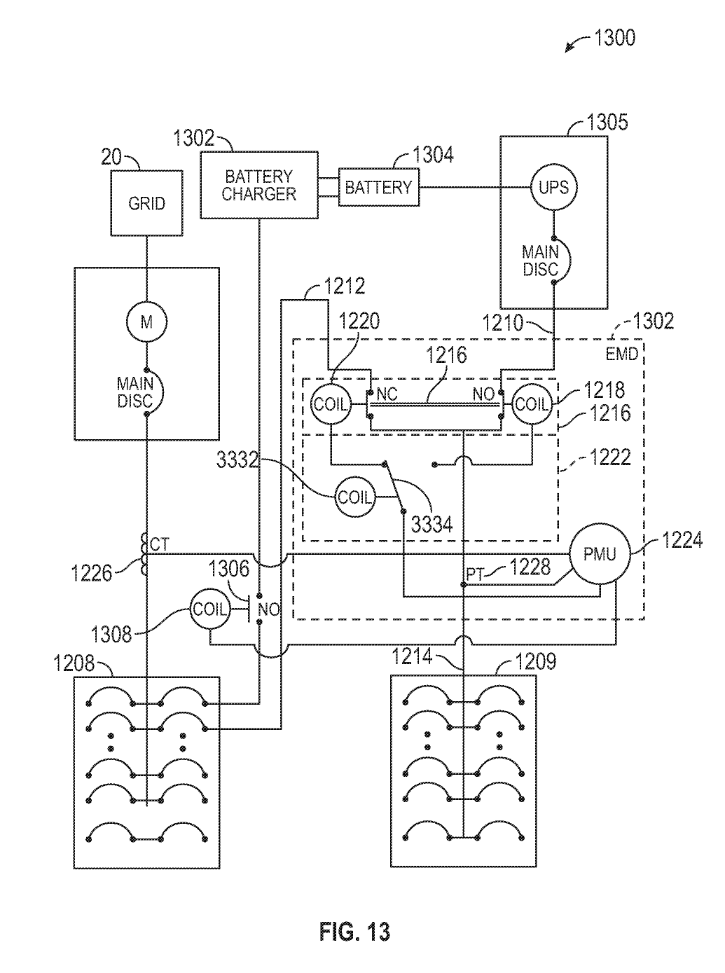

Referring to FIG. 13, portions of an exemplary EMS 1300 according to a first modification to the second embodiment will be discussed. The same portions shown in FIG. 12 have the same reference numerals and a detailed discussion is omitted. In this modification, the EMS 1300 utilizes an uninterrupted power supply (UPS) 1305.

The EMS 1300 includes a battery charger 1302 for charging a battery 1304 (first backup electrical power source) for the UPS 1305. The battery charger 1302 is connected to the facility electrical panel 1208 via a general purpose contactor 1306. A coil 1308 of the contactor 1306 is connected to the PMU 1224.

When the facility electrical demand at panel 1208 exceeds a predetermined level, the EMS 1300 initiates a transfer command so that the UPS 1305 provides power to the load diversion electrical panel 1209, thereby reducing the power demand from the grid 20. Particularly, the PMU 1224 is configured to measure current flow on the exterior path from the CT 1226; determine whether the measured current flow value is greater than a predetermined current flow rating associated with the grid 20; and when the measured current flow value is greater than a predetermined current flow rating associated with the grid 20, the PMU 1224 controls the latching relay 1222 by energizing the relay coil 3332 to switch the path to the first input terminal 1210 so that the UPS 1305 provides power to the load diversion electrical panel 1209. While the measured current flow value is less than the predetermined current flow rating, the PMU 1224 energizes the coil 1308 to provide an electrical path between the facility electrical panel 1208 and the battery charger 1302 so that the battery 1304 is charged. This EMS 1300 controls peak power demand from the grid. Therefore, normal operation is the grid 20 while backup is the UPS 1305. Otherwise, operation is similar to the EMS 1200.

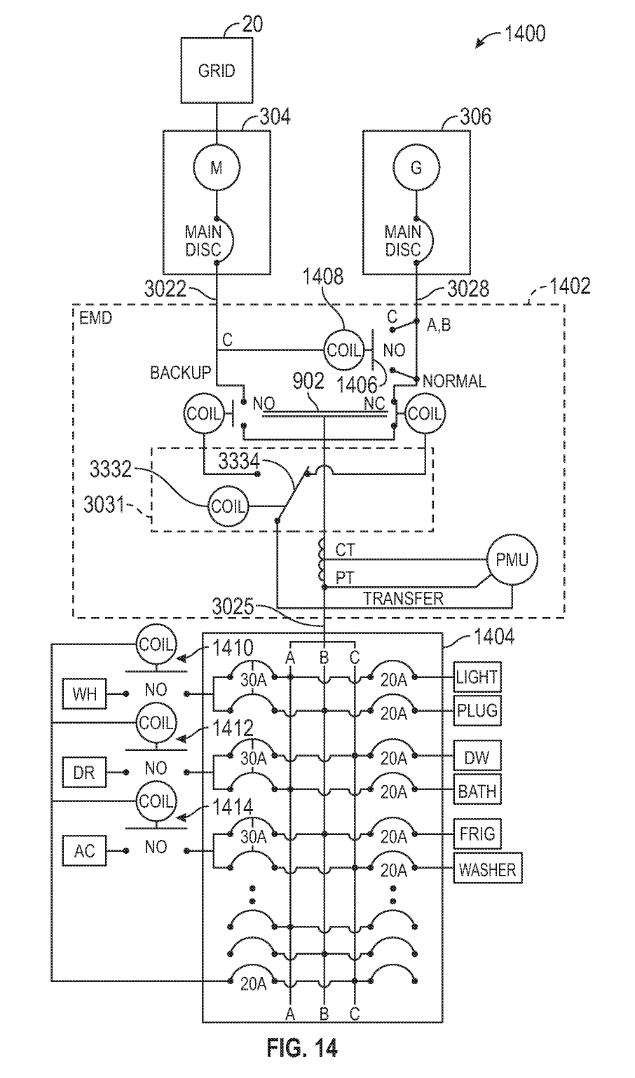

Referring to FIG. 14, portions of an exemplary EMS 1400 according to a third embodiment will be discussed. The same portions shown in FIG. 9 have the same reference numerals and a detailed discussion is omitted. The EMS 1400 reduces the power demand during a power outage of the grid 20. During the power outage, the only available source of power is from the AEPS 306. Accordingly, it is essential to preserve the available energy for the critical loads by de-energizing the non-essential loads. FIG. 14 shows operational states of the various portion of the EMS 1400 during a power outage.

The EMS 1400 includes an EMD 1402 connected to a multiple phase electrical panel 1404. In this example, the electrical panel 1404 has three phases (A, B, C). However, the EMS 1400 is not limited to a three phase electrical panel. Non-essential loads such as, for example, dishwasher (DW) and washer are connected to phase C while the critical loads are connected to phases A and B of the panel 1404.

The EMD 1402 includes a curtailment switch 1406 connected between the second input terminal 3028 and the reversing contactor 902. The curtailment switch 1406 includes a coil 1408 that is connected to the first input terminal 3022 so that it can be energized by the current flow of the first terminal 3022 from the grid. During a grid power outage, no current will flow through the first terminal 3022, thereby deenergizing the coil 1408 and thus phase C of second input terminal 3028. The electrical panel 1404 can include a plurality of general purpose contactors for preventing power to a plurality of circuits associated with the non-essential loads when the coil 1408 is not energized. In this example, each of the general purpose contactors 1410, 1412, 1414 has a coil that is connected to the phase C circuit of the electrical panel 1404. Accordingly, during the power outage of grid 20, phase C of electrical panel 1404 does not receive current because the coil 1408 of the curtailment switch 1406 is deenergized.

It should be noted that the curtailment switch 1406 can be applied to any of the embodiments discussed herein.

It should also be noted that any of the phases of the first input terminal 3022 or the combination of the phases of the first input terminal 3022 can be utilized to control coil 1408. Furthermore, any of the phases of the second input terminal 3028 or a plurality of phases of the second input terminal 3028 can be deenergized by contactor 902.

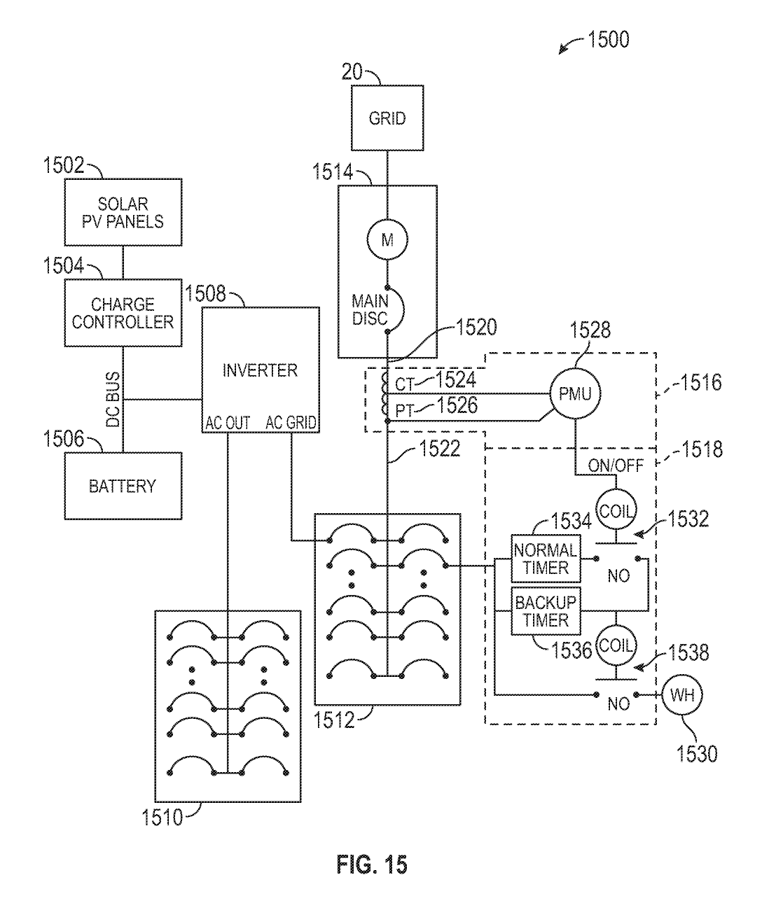

Referring to FIG. 15, portions of an exemplary EMS 1500 according to a fourth embodiment will be discussed. The EMS 1500 maximizes power utilization of the AEPS and minimizes the use of the grid 20. In this example the AEPS is a grid connected photovoltaic (PV) system with battery energy storage. The EMS 1500 includes solar PV panels 1502 (first electrical power source), a charge controller 1504 for charging a battery 1506 via a DC bus, an inverter 1508, a critical load panel 1510, an electrical panel 1512, a meter 1514 connected to the grid 20, an EMD 1516 and a load diversion controller (LDC) 1518. The inverter 1508 is connected to the solar PV panels 1502 (first electrical power source) via the DC bus to provide electrical power to the critical load panel 1510 and the electrical panel 1512. The electrical panel 1512 is connected to the meter 1514 to export electrical power to the grid 20 (second electrical power source).

The EMD 1516 includes an output terminal 1520 connecting with the meter 1514 and thus the grid 20 and an input terminal 1522 connecting with the facility electrical panel 1512. The EMD 1516 includes a CT 1524 for measuring a current flow on an interior path between the input and output terminals (1522, 1520) and a voltage sensor 1526 such as, for example, a PT for measuring voltages on the interior path. The EMD 1516 includes a PMU 1528 that controls the LDC 1518 based upon at least one of the measured current flow and measured voltage. The output from the CT 1524 and the PT 1526 are the inputs to the PMU 1528. Alternatively, for voltages of 600 V or less, rather than the PT 1526, a meter in the PMU 1528 can measure the voltage. The PMU 1528 can be a multifunction power meter which includes generally a microcontroller with metering capability for calculating the power based upon the measured current and voltage and comparing the calculated exported power with a predetermined power rating.

The LDC 1518 is connected to a circuit of the electrical panel 1512 and a load 1530 (water heater “WH” in this example). The LDC 1518 includes a first general purpose contactor 1532, a first (normal) timer 1534, a second (backup) timer 1536 and a second general purpose contactor 1538.

The coil of the first contactor 1532 is connected to the output of the PMU 1528. During operation, the first timer 1534 is set generally to a first timing value associated with the load 1530. For example, for a water heater, peak solar generation hours such as, for example, 12 pm to 3 pm can be the first timing value. When the coil of the first contactor 1532 is activated by the PMU 1528, LDC 1518 provides power to the load 1530 during the first timing value set by the first timing device 1534. The second timer 1536 can allow current to flow and activate the coil of the second contactor 1538 to provide an additional boost. The second timer 1536 is set to a second timing value associated with the load 1530 that is after the first timer value.

The PMU 1528 calculates an exported power based upon at least one of the measured current flow and the measured voltage on the interior path. When the PMU 1528 determines that the calculated power is greater than a predetermined power value, the PMU 1528 energizes the coil of the first contactor 1532 to turn on the water heater 1530. During ideal solar days, the water heater 1530 should be completely heated during the normal first timing value. However, during heavy cloudy/rainy days, the water heater 1530 may not be sufficiently heated. Accordingly, the second (backup) timer 1536 is set to the timing after the first timer 1534 has expired so that the LDC 1518 continues to provide power to the load 1530 until the second timing value set by the second timing device 1536 expires.

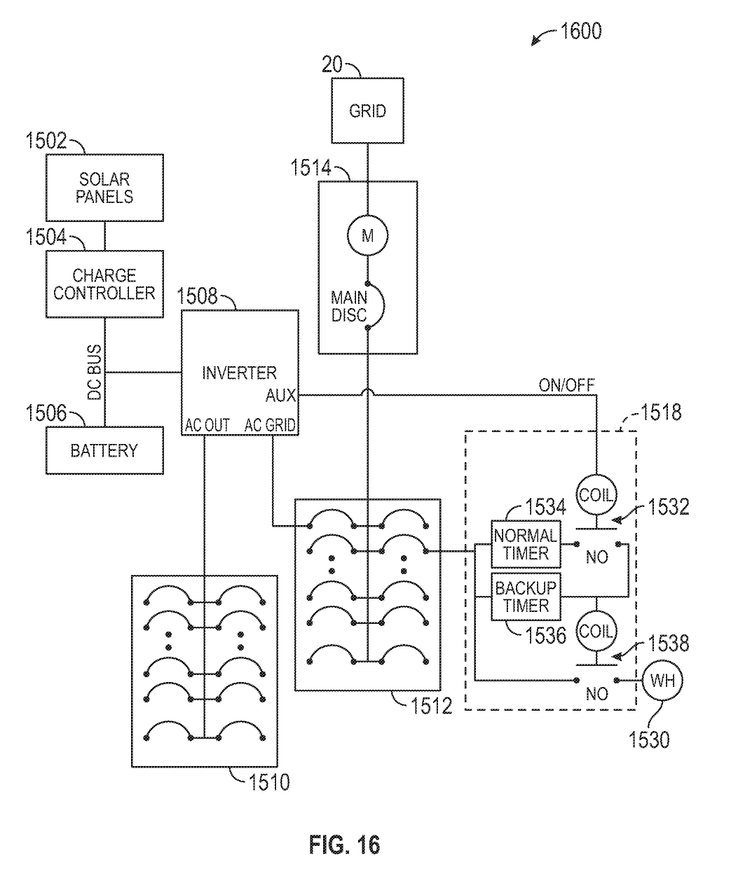

Referring to FIG. 16, portions of an exemplary EMS 1600 according to a first modification to the fourth embodiment will be discussed. The same portions shown in FIG. 15 have the same reference numerals and a detailed discussion is omitted. The EMS 1600 does not include an EMD. Rather, the coil of the first general purpose contactor 1532 is connected to and energized by an auxiliary output terminal of the inverter 1508. During normal operation, once the battery 1506 has been fully charged, the inverter 1508 activates the auxiliary control to energize the coil of the first contactor 1532. Otherwise, the EMS 1600 operates similarly to the EMS 1500.

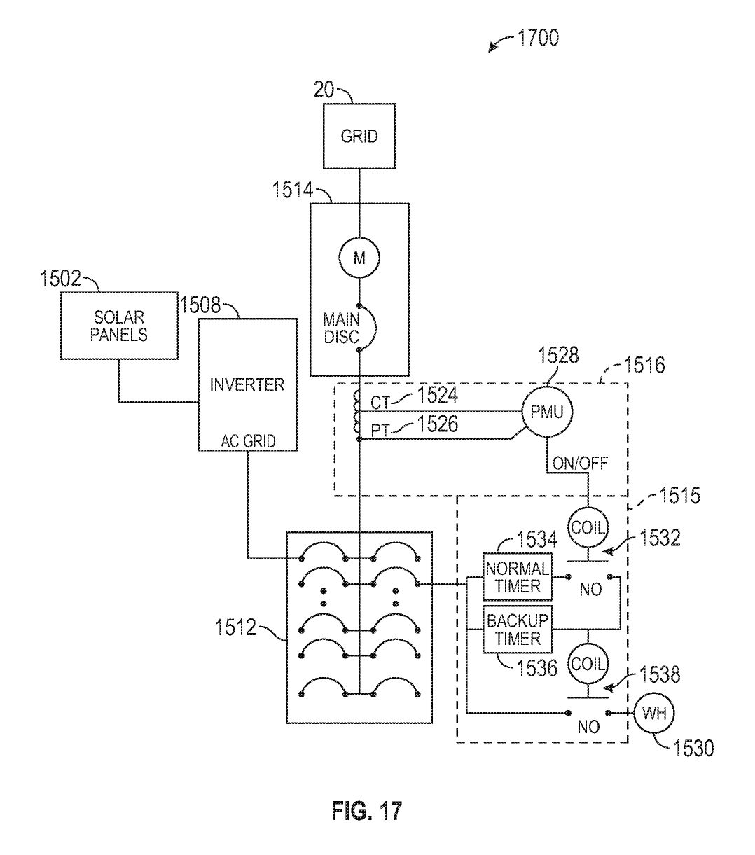

Referring to FIG. 17, portions of an exemplary EMS 1700 according to a second modification to the fourth embodiment will be discussed. The same portions shown in FIG. 15 have the same reference numerals and a detailed discussion is omitted. The EMS 1700 does not include a critical load panel, battery or charge controller as in FIG. 16. Rather, the solar panel 1502 is connected to the inverter 1508. Otherwise, the EMS 1700 operates similarly to the EMS 1500.

In some of the various embodiments, the CT can be, for example, a split core CT (model numbers AcuCT-2031, AcuCT-3147, AcuCT-3163) or Rogowski Coil made by Accuenergy. The PMU can be an Acuvim II-M-333-P2 made by Accuenergy. Although shown separately, the PMU can include a voltage sensing circuit as the PT 3028. The latching contactor can be a relay including a relay coil.

While only certain features of the invention have been illustrated and described herein, many modifications and changes will occur to those of ordinary skill in the art. The following claims are intended to cover all such modifications and changes.

What is claimed is:

1. An energy management device comprising:
a first input terminal connecting with a first backup electrical power source;
a second input terminal connecting with a second normally on electrical power source;
an output terminal connecting with an electrical panel of a facility;
a switching device providing a path between the output terminal and one of the first input terminal and the second input terminal;
a current transformer (CT) measuring a current flow across the path; and
a power management unit (PMU) configured to control the switching device to switch the path to the first input terminal when a power value calculated based upon at least one of the measured current flow and a measured voltage on the path is greater than a predetermined power rating associated with the second normally on electrical power source, the predetermined power rating greater than zero.

2. The energy management device of claim 1, wherein the PMU is further configured to control the switching device to switch the path back to the second input terminal when the power value calculated based upon the at least one of the measured current flow and the measured voltage is less than the predetermined power rating associated with the second normally on electrical power source.

3. The energy management device of claim 1, wherein a default state of the switching device is set to the second terminal so that the electrical panel receives electrical power from the second normally on electrical power source, the second normally on electrical power source being an alternative electric power source (AEPS).

4. The energy management device of claim 1, further comprising a voltage sensing circuit measuring the voltage across the path.

5. The energy management device of claim 1, wherein the switching device is a latching contactor.

6. The energy management device of claim 1, further comprising:
a reversing contactor including first and second coils connected to the first and second input terminals,
wherein the switching device is a relay,
wherein the PMU is connected to the first and second coils of the reversing contactor via a relay coil included in the relay, the PMU configured to switch between activating the first coil and the second coil and thereby switch the path to the output terminal between the first input terminal and the second input terminal based upon the at least one of the measured current flow and the measured voltage by energizing the relay coil.

7. An energy management device comprising:
a first input terminal connecting with a first backup electrical power source;
a second input terminal connecting with a facility electrical panel to receive electrical power via a meter from a second normally on electrical power source;
a CT measuring a current flow value across an exterior path between the facility electrical panel and the meter; and
a PMU configured to measure a voltage across an interior path between a load diversional electrical panel and one of the first input terminal and the second input terminal,
wherein the PMU is configured to switch the interior path between the first input terminal and the second input terminal based upon the measured current flow value on the exterior path.

8. The energy management device of claim 7, wherein the PMU is further configured to:
determine whether the measured current flow value is greater than a predetermined current flow rating; and
control the switching device to switch the interior path to the first input terminal when the measured current flow value is greater than the predetermined current flow rating, the predetermined current flow rating greater than zero.

9. The energy management device of claim 8, wherein the PMU is further configured to control the switching device to switch the path back to the second input terminal when the measured current flow value becomes less than the predetermined current flow rating.

10. The energy management device of claim 7, further comprising:
a general purpose contactor including a coil connected to the PMU, the general purpose contactor connected to a battery charger and the electrical panel, the battery charger configured to charge a battery which is the first backup electrical power source,
wherein the PMU is further configured to energize the coil of the general purpose contactor while the measured current flow value is less than the predetermined current flow rating.

11. An energy management device comprising:
an output terminal connecting with a meter associated with a first electrical power source;
an input terminal connecting with a facility electrical panel for exporting power to the first electrical power source via the output terminal;
a PMU including:
a CT measuring a current flow across an interior path from the first input terminal to the output terminal; and
a PT measuring a voltage across the interior path; and
a load diversion controller (LDC) connected to the electrical panel and a load, the LDC including a general purpose contactor and a coil, the LDC configured to provide electrical power to the load during a specific time period while the coil is energized by the PMU,
wherein the PMU calculates a power based upon at least one of the measured current flow and the measured voltage on the interior path, and when the PMU determines that the calculated power is greater than a first predetermined power value, the PMU energizes the coil in the LDC.

12. The energy management device of claim 11, wherein the LDC includes a first timing device set for a first timing value associated with the load, wherein when the coil in the LDC is activated by the PMU the LDC continues to provide power to the load until the first timing value set by the first timing device expires.

13. The energy management device of claim 12, wherein the LDC includes a second timing device set for a second timing value associated with the load, wherein the LDC provide power to the load until the second timing value set by the second timing device expires.

14. An energy management system including the energy management device of claim 11, the energy management system further comprising:
an inverter connected to the second electrical power source, the inverter providing electrical power to the electrical panel to be exported to the second electrical power source.

15. The energy management system of claim 14, wherein the inverter is coupled to a charger controller for charging a battery and is configured to energize the coil in the LDC when the battery is charged to a predetermined amount.

16. The energy management device of claim 14,
wherein the second electrical power source is an alternative electric power source (AEPS) charging a battery,
wherein the inverter further comprising an auxiliary output terminal for activating the LDC after the battery has been charged by the battery charger.

17. The energy management device of claim 1, further comprising:
a curtailment switch arranged to switch a connection to one of a first terminal and a second terminal, the curtailment switch including a coil energized when current flows through the first input terminal.

18. The energy management device of claim 17, wherein the electrical panel includes a first circuit breaker for preventing power to a plurality of circuits when the coil associated with the curtailment switch is not energized.
